(19) United States
(12) Patent Application Publication
(10) Pub. No.: US 2016/0170931 A1
(43) Pub. Date: Jun. 16, 2016

(54) CONSOLE SERVER WITH USB CONSOLE PORT

(71) Applicant: Lantronix, Inc., Irvine, CA (US)

(72) Inventors: Van Quach, Irvine, CA (US); Matthew Davison, Irvine, CA (US)

(21) Appl. No.: 14/967,018

(22) Filed: Dec. 11, 2015

Related U.S. Application Data
(60) Provisional application No. 62/091,406, filed on Dec. 12, 2014.

(51) Int. Cl. G06F 13/42; G06F 13/40

(52) U.S. Cl. CPC G06F 13/4282; G06F 13/4022

(57) ABSTRACT

A console server that can be configured to include USB and RJ-45 serial ports is disclosed. The USB serial ports are provided by a USB serial card, and are configured to provide communications with a device having a USB serial port, but lacking an RJ-45 serial port.

### PRIORITY

This application claims the benefit of and priority to U.S. Provisional Application No. 62/091,406 filed on Dec. 12, 2014, entitled “Console Server With USB Console Port.”

### BACKGROUND

The present invention is directed to remote monitoring and control of various devices that are connected to a network. More specifically, the present invention is directed to a monitoring server providing universal serial bus (USB) connectivity between the monitoring server and devices connected to the monitoring server.

Console servers provide systems administrators and other Information Technology (“IT”) professionals a variety of tools to securely access and manage their resources. Using a console server, a network manager may configure, administer and manage various types of IT equipment in a variety of ways. The types of equipment that can be accessed and administered using a console server include, but are not limited to, servers, networking equipment such as routers, switches, storage networking, telecommunications equipment, such as PBX and voice switches, and other systems with serial interfaces, such as, for example, heating/cooling systems, security systems, and building access systems, uninterruptible power supplies, and medical devices.

Until recently, most equipment included an RS-232 serial port, sometimes called a console, auxiliary or management port, through which the equipment could be operated or administered using a computer, such as a laptop, terminal, or other equipment having a processor which could be used to communicate with and/or control the equipment being managed. Thus, the administrator communicating with the equipment needed to be in the same physical location as the equipment being managed.

Console servers or managers were developed to provide the administrator a way to access the IT equipment remotely from anywhere there is a network or modem connection. The console server is located between the IT device to be communicated and controlled and a network, which may be the Internet. The console server provides for remote management and troubleshooting of the IT device without sending a technician onsite. This reduces travel costs and downtime costs, as well as providing instant access to the IT device, reducing response time when unexpected events that affect the operation of the IT device occur. Some console servers also incorporate modern access so that the IT devices can be administered even if there is a network outage.

Modern console servers typically include a plurality of RJ-45 connection ports, usually arranged in one or more modular assemblies that are inserted into an available bay of a console server. For example, a module may include a number of RJ-45 ports, perhaps 8, 16, 32 or more ports.

Recently, however, serial access to the IT device using serial ports is being phased out in favor of Universal Serial Bus (“USB”) ports, which allow for more rapid information transfer rates and offer other advantages. Since console servers typically only offer RJ-45 serial ports, an adapter must be used to allow communication between the RJ-45 serial port of the console server and the USB serial port of the IT device.

What has been needed, and not previously available, is a console server configured to accept a module that includes one or more USB ports that may be used to connect to equipment that lack a conventional RS-232 serial port or an RJ-45 serial port. Such a console could then be directly connected to the device to be managed using a connector cable having USB connectors on each end, thus eliminating the need for either an adaptor, or a special cable that includes an RJ-45 serial connector at one end for insertion into the console and a USB adaptor for connecting to the device. Such a module could be configured to include a plurality of USB serial ports, or it could be configured to include both USB and RJ-45 serial ports, thus offering increased flexibility. The present invention satisfies these and other needs.

### SUMMARY OF THE INVENTION

In its most general aspect, the invention includes a console server that includes USB ports for connecting the console server to devices that do not possess RJ-45 serial connection ports. One advantage of such a console server is to eliminate the need for RJ-45 to USB cables or translator modules in those instances where a device to be monitored and/or controlled does not have an RJ-45 serial port.

In another general aspect, the invention includes a console server having a plurality of bays, each bay being configured to receive a communication card, which may be either a USB card or a conventional RJ-45 card. An advantage of such a console server is to provide improved flexibility in IT environments having both older equipments that only have RJ-45 serial connection ports, and new equipment having only USB connection ports.

In still another aspect, the invention includes a console server, comprising: a USB port connectable to a device for providing communication with the device; and a network connection in communication with the USB port, wherein the device may be monitored or controlled through the network connection. In one alternative aspect, an RJ-45 serial port connectable to a device is included. In a further aspect, the console server may comprise a host controller and a hub electrically disposed between the USB port and the network connection.

In yet another aspect, the network connection is an Ethernet connection. In one alternative aspect the network connection is configured for communication over a telephone line. In another alternative aspect, the network connection is a wireless network connection. In yet another alternative aspect, the network connection is a cellular network connection.

In another aspect, the invention includes a console server, comprising: a main circuit board including a processor, a memory in communication with the processor, a communication bus in communication with the processor, and a network interface card in communication with the processor; a USB serial card in communication with the communication bus, the USB serial card in communication with the communication bus, the USB serial card including a host controller and at least one hub, the at least one hub in communication with a USB serial port configured for connection to a device to be monitored and/or controlled; and a network port in communication with the network interface card, the network port configured for connection to a network wherein information related to a device connected to the USB serial port may be transmitted to and received from a user connected to the network.

In an alternative aspect, the network port is in wireless communication with the network. In a further aspect, the console server also includes a dial-up connection port in communication with the processor, the dial up connection port configured to transmit and receive information related to the device connected to the USB serial port. In yet another alternative aspect, the network port is in with a cellular network.

In still another aspect, the invention includes a console server, comprising: a main circuit board including a processor, a memory in communication with the processor, a communication bus in communication with the processor, and a network interface card in communication with the processor; a USB serial card in communication with the communication bus, the USB serial card in communication with the communication bus, the USB serial card including a host controller and at least one hub, the at least one hub in communication with a USB serial port configured for connection to a device to be monitored and/or controlled; an RJ-45 serial card in communication with the communication bus, the RJ-45 serial card in electronic communication via circuitry with at least one RJ-45 port configured for connection to a device to be monitored and/or controlled; and a network port in communication with the network interface card, the network port configured for connection to a network wherein information related to a device connected to the USB port may be transmitted to and received from a user connected to the network.

In yet another aspect, the network port is in wireless communication with the network. In still another aspect, the console may include a dial-up connection port in communication with the processor, the dial up connection port configured to transmit and receive information related to the device connected to the USB serial port. In yet another aspect, the network port is in communication with the network through an Ethernet connection. In still another aspect, the dial-up connection is configured to be connected to a telephone line. In yet another alternative aspect, the network port is in communication with a cellular network.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a graphic representation of an exemplary embodiment illustrating the monitoring and control of network connected devices using a console server having USB connectivity.

FIG. 2 is a rear perspective view of a console server in accordance with the various embodiments of the present invention showing two port bays providing USB serial port connections and one port bay providing RJ-45 serial port connections.

FIG. 3 is schematic representation of electronic modules of the embodiment of FIG. 2.

FIG. 4 is a schematic representation of various components of an exemplary USB serial card core architecture.

### DETAILED DESCRIPTION OF THE PREFERRED EMBODIMENTS

As will be described hereinafter in greater detail, the various embodiments of the present invention relate to an apparatus and method for providing USB port connections in a console server for connecting the console server to various devices using a USB cable and connections instead of the legacy RJ-45 or other traditional serial cables and connectors. For purposes of explanation, specific nomenclature is set forth to provide a thorough understanding of the present invention. Description of specific applications and methods are provided only as examples. Various modifications to the embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

In the following description, numerous specific details are set forth in order to provide a thorough understanding of the present invention. It will be apparent, however, to one of ordinary skill in the art, that the present invention may be practiced without these specific details. In other instances, well known components or methods have not been described in detail but rather in a block diagram, or a schematic, in order to avoid unnecessarily obscuring the present invention. Further specific numeric references such as “first driver,” may be made. However, the specific numeric reference should not be interpreted as a literal sequential order but rather interpreted that the “first driver” is different than a “second driver.” Thus, the specific details set forth are merely exemplary. The specific details may be varied from and still be contemplated to be within the spirit and scope of the present invention. The term “coupled” is defined as meaning connected either directly to the component or indirectly to the component through another component.

Throughout the description reference will be made to various software programs and hardware components that provide and carryout the features and functions of the various embodiments of the present invention. Software programs may be embedded onto a machine-readable medium. A machine-readable medium includes any mechanism that provides, stores or transmits information in a form readable by a machine, such as, for example, a computer, server or other such device. For example, a machine-readable medium includes read only memory (ROM); random access memory (RAM); magnetic disk storage media; optical storage media; flash memory devices; digital video disc (DVD); EPROMs; EEPROMs; flash memory; magnetic or optical cards; or any type of media suitable for storing electronic instructions.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in software, or a combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In an embodiment, the logic consists of electronic circuits that follow the rules of Boolean Logic, software that contain patterns of instructions, or any combination of both.

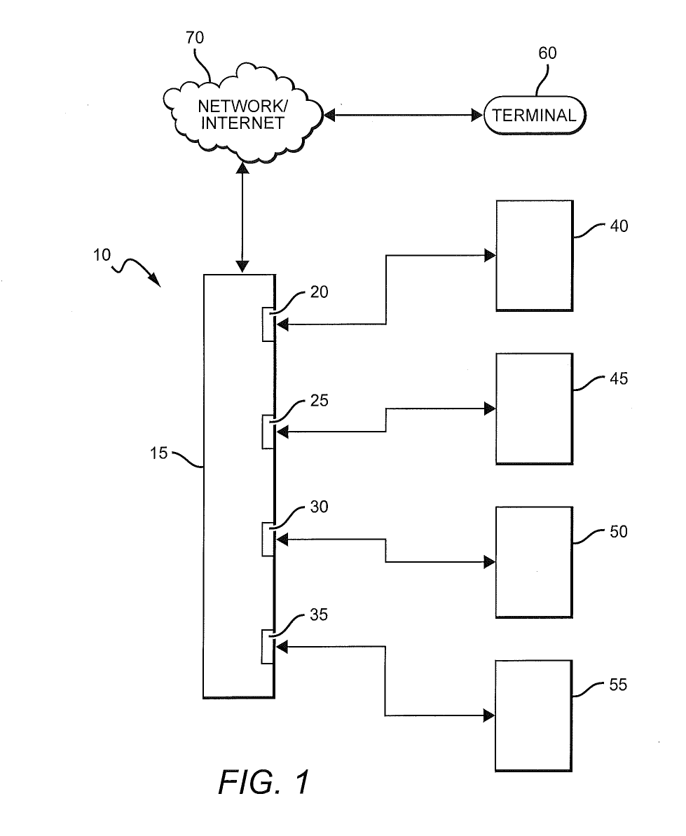

FIG. 1 is a graphic representation of an exemplary embodiment showing a monitoring and control system 10 that includes a console server 15 connected to devices or systems 40, 45, 50 and 55. A terminal, computer, tablet, smartphone or the like 60 communicates with the console server 15 via a network or Internet connection 70.

In this embodiment, devices or systems 40, 45, 50, 55 are connected to the console server through serial ports 20, 25, 30, 35 respectively. In this manner terminal or computer 60 may be used to monitor and control the activities of devices or systems 40, 45, 50, 55 through the console server 15.

It will be understood that devices or systems 40, 45, 50, 55 may be individual devices having a processor, associate memory, and software programs for operating the devices stored in the memory or embedded in the processor, or they may be systems having similar components. Such systems may include systems and networks, including other computers, servers, and other devices connected to the system or network.

Similarly, terminal or computer or other device 60 will include a processor, memory and software comprised of programming commands for operating the terminal or computer 60 and for configuring the terminal or computer 60 for communicating through network 70 with console server 15. The terminal or computer 60 may also include software programs comprising programming commands for initiating a communication session with console server 15, and for providing instructions to the console server to be used to monitor the activities of the devices and systems connected to console server 15, and to extract information from the devices or systems 40, 45, 50, 55 pertaining to the operation of those devices or systems.

As discussed above, terminal or computer 60 may be, for example, but not limited to, a thin client, a personal computer such as a WINDOWS or Linux machine, a workstation, a tablet, a smartphone or other device. The network 70 may be a wide area network (WAN), local area network (LAN), TCP/IP network, a wireless network, a cellular network, the Internet, and/or a dial-up connection that uses a plain old telephone system (POTS), cable or DSL technology.

Console server 15 includes a plurality of ports 20, 25, 30 and 35 that are configured to connect devices such as servers, network gear or other devices to the console server. The number of ports may be varied, such as, for example, there may be 4, 8, 16, 32, 48, 64 or more ports.

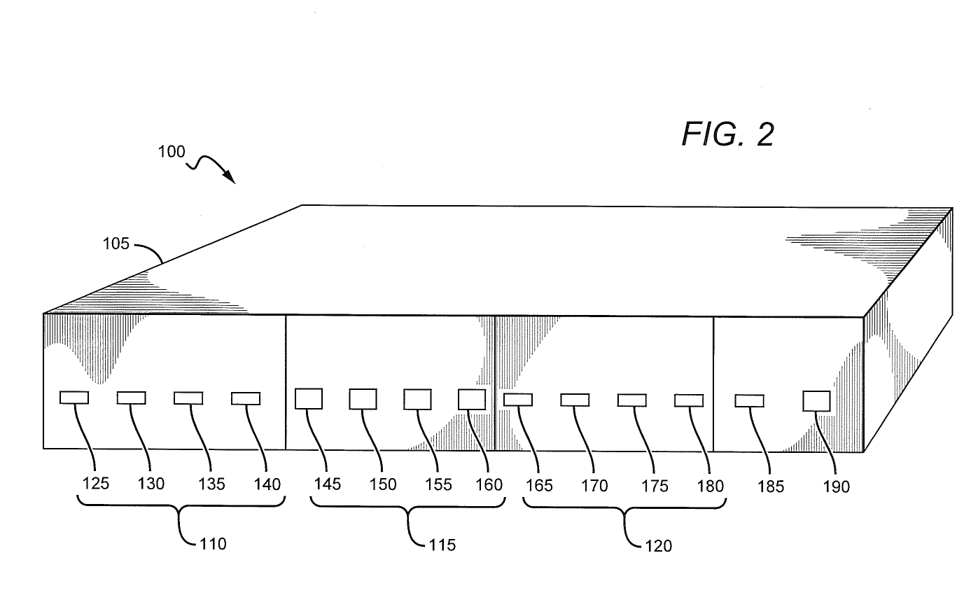

FIG. 2 is a perspective rear view of one embodiment of a console server 100 in accordance with the principles of the present invention. As shown, console server 100 includes a housing 105. A rear side of the housing is shown having three port bays 110, 115 and 120. These bays are configured to accept an assembly or card that carries one or more serial ports. In the embodiment shown, the card inserted into bay 110 has, for example, four serial ports, ports 125, 130, 135 and 140. These ports are configured as USB ports having, for example, USB connectors configured to accept a USB connector of a serial cable. It is known in the art that such USB connectors may comprise either “male” or “female” connectors, and suitable connectors are used as desired.

Bay 115 is shown having RJ-45 connectors configured to accept an RJ-45 connector. Bay 120, similar to bay 110 is shown having USB connectors configured to accept USB connectors of a serial cable. It is known in the art that such RJ-45 connectors may comprise either “male” or “female” connectors, and suitable connectors are used as desired

As shown, the cards in each of bays 110, 115 and 120 are shown having four serial ports. Those skilled in the art will appreciate that more than four ports may be included in each bay. For example, each bay may include 8, 16, 32 or more ports. In some configurations, each bay may include a different number of ports.

Console server 100 also includes a USB port 185 and an Ethernet and/or modem port 190. These ports may be used to connect the console server to a network or the Internet, a dial up connection, or to a cellular network. USB port 185 may also be used to directly connect the console server to a terminal, storage facility, or other device that may be used to control or monitor the operation of the console server.

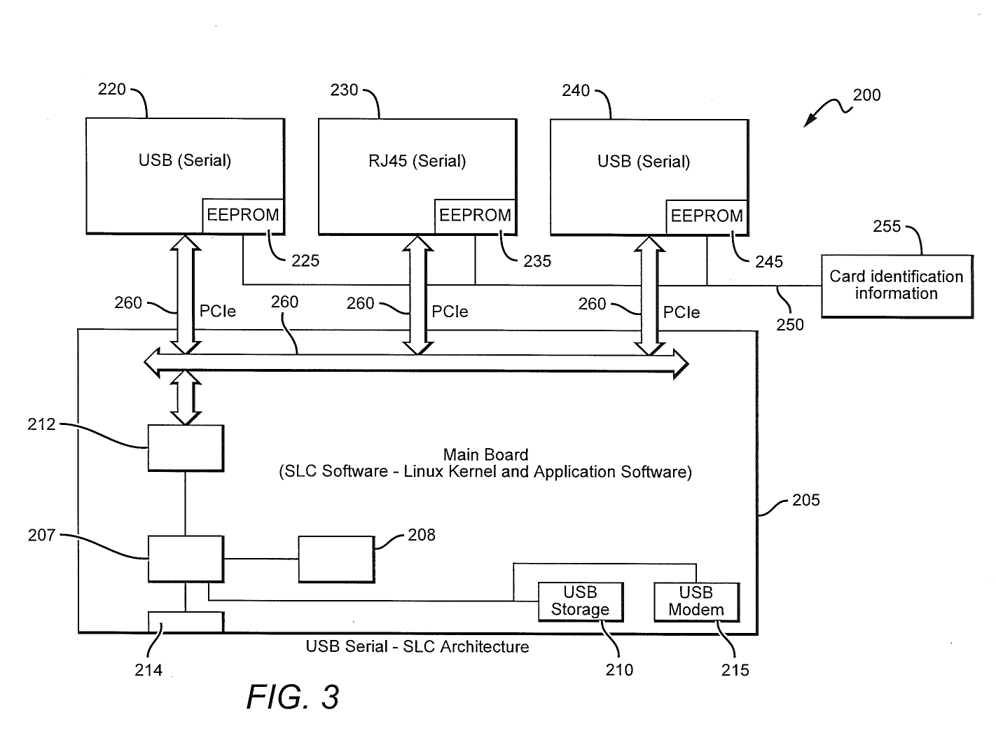

FIG. 3 is a schematic representation of the electronic circuitry and modules comprising an embodiment of the console server 200 of the present invention. In this embodiment, the console server includes a main circuit board 205. Main circuit board 205 includes a processor 207 and memory 208. Processor 207 is in communication with a communications module 212, which is also in communication with a peripheral component interconnect (PCIE) bus 260. Main circuit board 205 also includes a module 214 for controlling communications to a network, such as a LAN, WAN, cellular network, or the internet. A USB storage controller and port 210 and a modem controller and port 215 are also included.

One or more serial cards 220, 230 and 240 may be plugged into connectors of the PCIE bus 260, placing the serial cards in communication with the processor 212 of the main circuit board. Each of serial cards 220, 230 and 240 include a memory 225, 235 and 245 respectively, which may be EEPROM memory. Card identification information 255, which may include information related to the identification and configuration of the serial ports of each of the serial cards 220, 230, 240 may be communicated to the serial cards and stored in the EEPROMs of each card via I2C communication bus 250. The card identification information may be stored in a memory accessible to the processor 207, and provided by the processor to the serial cards via the I2C bus 250.

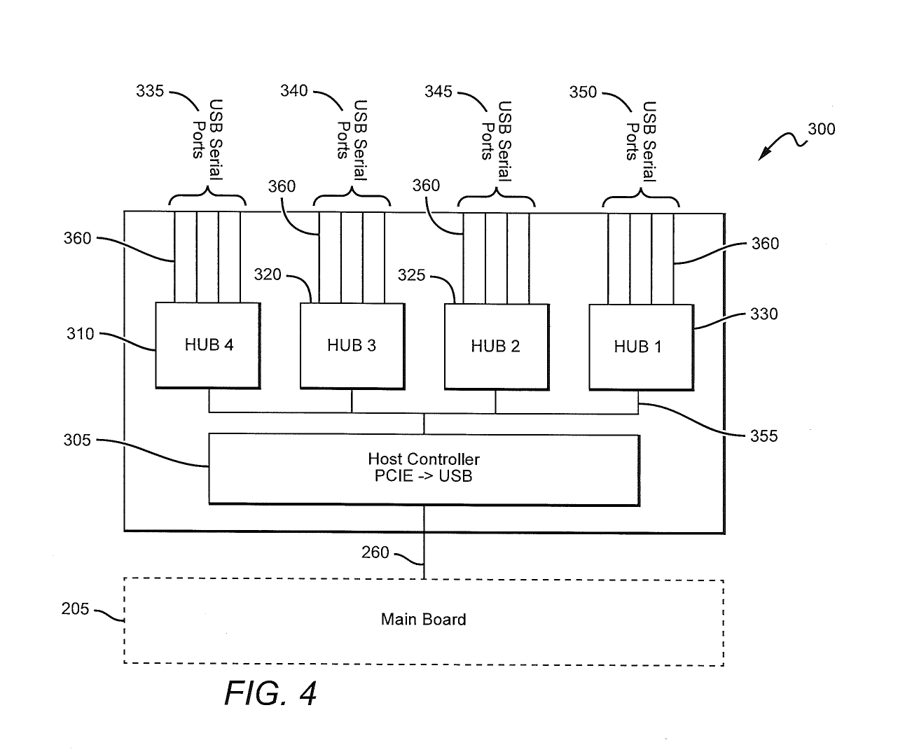

FIG. 4 illustrates an exemplary architecture for a USB serial card 300 which may be connected to main circuit board 205 through the PCIE bus 260, as discussed above. USB serial card 300 includes a host controller 305, which communicates with one or more hubs 310, 320, 325, 330 via communication bus 355. Each hub controls the operation of up to four USB ports 335, 340, 345, 350 over communication lines 360. Note that, in this exemplary embodiment, each line 360 connects to a single USB port. Thus, the USB ports 335 may indicate one to four individual USB ports, port 340 may indicate one to four individual USB ports, and similarly for ports 345 and 350. Host controller 305 translates the signals transmitted to or received from the PCIE bus into signals configured to be communicated in conformance with a USB protocol.

Suitable drivers and software programs for operating the USB cards are provided under the control of the processor of the main circuit board. The drivers, dependent on the hardware and software available, may comply with any of the current or future USB standards, such as, for example, but not limited to, USB 1.0, USB 2.0, USB 3.0 and the like, including any sub-versions of those, or future versions or standards.

Referring again to serial board 230 of FIG. 3, one skilled in the art will understand that this board utilizes a USB protocol, and provides serial ports for communicating using the RS232, RS422, RS 485 or other serial “com” port type communication protocols. One advantage of the present invention is the ability to provide both RJ-45 serial ports and USB serial ports in a single console server, allowing for the monitoring and control of virtually any device without needing to provide for translation between, for example, an RS232 compliant data stream and a USB compliant data stream, which is necessary where a console server has only RJ-45 serial ports and the device to be monitored and controlled has only a USB serial port. Thus, the various embodiments of the present invention provide for easier connection of devices and systems to the console server, as well as providing improved performance and reliability, including reducing data loss that may occur when USB protocol based signals are translated to RJ-45 based signals, and vice versa.

It will be understood by those skilled in the art that references to a computer refer to a processor or system of processors and associated electrical circuitry, and may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, and the like. A computer or system may be a combination of multiple forms, including one or more computer systems, be unitary or distributed, span multiple locations, span multiple systems, or reside in a cloud (which may include one or more cloud components in one or more networks.

A computer may include one or more processors, memory, storage, an input/output (I/O) interface, a communication interface, and a bus. Although this disclosure describes and illustrates a particular system having a particular number of particular components in a particular arrangements, this disclosure contemplates other forms of computer systems having any suitable number of components in any suitable arrangement.

In one embodiment, a processor includes hardware for executing instructions, such as those making up software. Herein, reference to software may encompass one or more applications, byte code, one or more computer programs, one or more executables, one or more instructions, logic, machine code, one or more scripts, or source code, and vice versa, where appropriate. As an example and not by way of limitation, to execute instructions, a processor may retrieve the instructions from an internal register, an internal cache, memory or storage; decode an execute them; and then write one or more results to an internal register, an internal cache, memory, or storage. In one embodiment, the processor may include one or more internal caches for data, instructions, or addresses. Memory may be random access memory (RAM), static RAM, dynamic RAM or any other suitable memory. Storage maybe a hard drive, a floppy disk drive, flash memory, an optical disk, magnetic tape, or any other form of storage device that can store data (including instructions for execution by a processor.

Storage may be mass storage for data or instructions which may include, but not limited to, a HDD, solid state drive, disk drive, flash memory, optical disc (such as a DVD, CD, Blu-ray, and the like), magneto optical disc, magnetic tape, or any other hardware device which stores may store computer readable media, data and/or combinations thereof. Storage maybe internal or external to computer system 500.

In one embodiment, an input/output (I/O) interface may include hardware, software, or both for providing one or more interfaces for communication between a process or computer and on or more I/O devices. As an example but not by way of limitation, an I/O device may include one or more mouses, keyboards, keypads, cameras, microphones, monitors, display, printers, scanners, speakers, cameras, touch screens, trackball, or the like.

In still another embodiment, a communication interface in communication with the processor includes hardware, software, or both providing one or more interfaces for communication between one or more computer systems, devices or one or more networks. The communication interface may include a network interface controller (NIC) or a network adapter for communicating with an Ethernet or other wired-based network or a wireless NIC or wireless adapter for communications with a wireless network, such as a WI-FI network, or to a cellular network. In one embodiment, the bus includes any hardware, software, or both coupling components of a computer system to each other.

While particular embodiments of the present invention have been described, it is understood that various different modifications within the scope and spirit of the invention are possible. The invention is limited only by the scope of the appended claims.

We claim:

1. A console server, comprising:
a USB serial port connectable to a device for providing communication with the device;
a network connection in communication with the USB serial port, wherein the device may be monitored or controlled through the network connection.

2. The console server of claim 1, further comprising an RJ-45 serial port connectable to a device.

3. The console server of claim 1, further comprising a host controller and a hub electrically disposed between the USB serial port and the network connection.

4. The console server of claim 1, wherein the network connection is an Ethernet connection.

5. The console server of claim 1, wherein the network connection is configured for communication over a telephone line.

6. The console server of claim 1, wherein the network connection is a wireless network connection.

7. The console server of claim 1, wherein the network connection is configured to communicate over a cellular network.

8. A console server, comprising:
a main circuit board including a processor, a memory in communication with the processor, a communication bus in communication with the processor, and a network interface card in communication with the processor;
a USB serial card in communication with the communication bus, the USB serial card in communication with the communication bus, the USB serial card including a host controller and at least one hub, the at least one hub in communication with a USB serial port configured for connection to a device to be monitored and/or controlled; and
a network port in communication with the network interface card, the network port configured for connection to a network wherein information related to a device connected to the USB port may be transmitted to and received from a user connected to the network.

9. The console server of claim 8, wherein the network port is in wireless communication with the network.

10. The console server of claim 8, further comprising a dial-up connection port in communication with the processor, the dial up connection port configured to transmit and receive information related to the device connected to the USB serial port.

11. The console server of claim 8, further comprising an RJ-45 serial card in communication with the communication bus, the RJ-45 serial card in electronic communication via circuitry with at least one RJ-45 port configured for connection to a device to be monitored and/or controlled.

12. The console server of claim 8, wherein the network port is in communication with the network through an Ethernet connection.

13. The console of claim 8, wherein the network port is configured to communicate over a cellular network.

14. The console server of claim 10, wherein the dial-up connection is configured to be connected to a telephone line.

15. A console server, comprising:
a main circuit board including a processor, a memory in communication with the processor, a communication bus in communication with the processor, and a network interface card in communication with the processor;
a USB serial card in communication with the communication bus, the USB serial card in communication with the communication bus, the USB serial card including a host controller and at least one hub, the at least one hub in communication with a USB serial port configured for connection to a device to be monitored and/or controlled;
an RJ-45 serial card in communication with the communication bus, the RJ-45 serial card in electronic communication via circuitry with at least one RJ-45 port configured for connection to a device to be monitored and/or controlled; and
a network port in communication with the network interface card, the network port configured for connection to a network wherein information related to a device connected to the USB port may be transmitted to and received from a user connected to the network.

16. The console server of claim 15, wherein the network port is in wireless communication with the network.

17. The console server of claim 15, further comprising a dial-up connection port in communication with the processor, the dial up connection port configured to transmit and receive information related to the device connected to the USB serial port.

18. The console server of claim 15, wherein the network port is in communication with the network through an Ethernet connection.

19. The console server of claim 15, wherein the network port is in communication with the network through a cellular connection.

20. The console server of claim 17, wherein the dial-up connection is configured to be connected to a telephone line.
